(19) United States
(12) Patent Application Publication
(10) Pub. No.: US 2015/0323767 A1
(43) Pub. Date: Nov. 12, 2015

(54) PROJECTION LENS AND PROJECTOR

(71) Applicant: SEIKO EPSON CORPORATION, Tokyo (JP)

(72) Inventors: Eiji MORIKUNI, Matsumoto-Shi (JP); Nobutaka MINEFUJI, Azumino-Shi (JP)

(21) Appl. No.: 14/702,327

(22) Filed: May 1, 2015

(30) Foreign Application Priority Data
May 12, 2014 (JP) 2014-098373

(51) Int. Cl. G02B 13/16; G02B 13/18; G02B 9/64

(52) U.S. Cl. CPC G02B 13/16; G02B 9/64; G02B 13/18

(57) ABSTRACT

A projection lens includes, in order from an enlargement side, a first optical system, a second optical system, and a third optical system. At least a portion of an intermediate image is formed so as to overlap the second optical system.

### BACKGROUND

1. Technical Field

The present invention relates to a projection lens suitable for incorporation into a projector that enlarges and projects an image of an image display element, and a projector incorporating the projection lens.

2. Related Art

As a projection lens for a projector, a projection lens including, in order from a light valve, a first optical system configured to include a refracting system and having positive power, and a second optical system configured to include a reflective surface and having positive power, in which an intermediate image formed between the first optical system and the reflective surface is enlarged and projected by the reflective surface, has been publicly known (refer to JP-A-2007-316674).

In the projection lens described above, it is necessary for improving optical performance at, for example, a high image height position (periphery away from an optical axis) to control imaging performance with a mirror surface such that the size of a mirror on the exiting side is increased to spread a bundle of rays of peripheral light on the mirror surface. That is, it is not easy to achieve high image quality at the periphery while suppressing an increase in the size of the mirror on the exiting side. Therefore, the use of the projection lens described above causes an increase in the size of a projector.

### SUMMARY

An advantage of some aspects of the invention is to provide a projection lens capable of achieving high image quality while suppressing an increase in the size of an optical system on an exiting side, and a projector incorporating the projection lens.

A projection lens according to an aspect of the invention includes: in order from an enlargement side, a first optical system; a second optical system; and a third optical system, wherein at least a portion of an intermediate image is formed so as to overlap the second optical system. The sentence “at least a portion of the intermediate image is formed so as to overlap the second optical system” means that at least a portion of the intermediate image is formed inside an optical element constituting the second optical system.

According to the projection lens, since at least a portion of the intermediate image is formed so as to overlap the second optical system, an imaging state of the intermediate image or a light exiting state from the intermediate image can be effectively controlled by the second optical system. With this configuration, rays can be easily controlled by the second optical system at, for example, the periphery away from the optical axis, and thus high image quality can be achieved at the periphery without much increasing the size of the first optical system on the enlargement side or exiting side.

According to a specific aspect of the invention, the second optical system includes at least one lens, and at least the portion of the intermediate image is formed so as to overlap the lens. In this case, the state of a ray at an area close to the intermediate image can be adjusted for each of image heights by both an incident surface and an exiting surface of the lens, and thus imaging performance can be further improved. The lens can be disposed on the optical path in a space saving manner, so that the intermediate image can be relatively easily formed so as to overlap the lens.

According to another aspect of the invention, the lens provided in the second optical system is an aspheric lens.

According to still another aspect of the invention, the first optical system includes a concave mirror, and the third optical system is formed of at least one lens. That is, the intermediate image formed by the lens of the third optical system and the second optical system is enlarged and projected by the first optical system including the concave mirror.

According to yet another aspect of the invention, the first optical system is formed of one concave mirror having positive power, the second optical system is formed of a single lens, and the third optical system is configured to include a plurality of lenses. The intermediate image can be formed at a desired position by the third optical system and the like, and the formed intermediate image can be enlarged and projected by the concave mirror having positive power.

According to still yet another aspect of the invention, the second optical system and the third optical system in combination have positive power.

A projector according to further another aspect of the invention includes: the projection lens described above; and an image forming optical unit provided at a front stage of an optical path of the projection lens.

### BRIEF DESCRIPTION OF THE DRAWINGS

The invention will be described with reference to the accompanying drawings, wherein like numbers reference like elements.

FIG. 1 is a diagram showing a schematic configuration of a projector incorporating a projection lens of a first embodiment.

FIG. 2 is a cross-sectional view of the projection lens of the first embodiment.

FIG. 3 is a schematic view for explaining an advantageous effect of the invention.

FIGS. 4A to 4C are conceptual views for explaining an imaging position of an intermediate image formed in the projection lens.

FIG. 5 is a cross-sectional view of a projection lens of a second embodiment.

FIG. 6 is a cross-sectional view of a projection lens of a third embodiment.

### DESCRIPTION OF EXEMPLARY EMBODIMENTS

### First Embodiment

A projection lens according to a first embodiment and a projector incorporating the projection lens will be described in detail below with reference to the drawings.

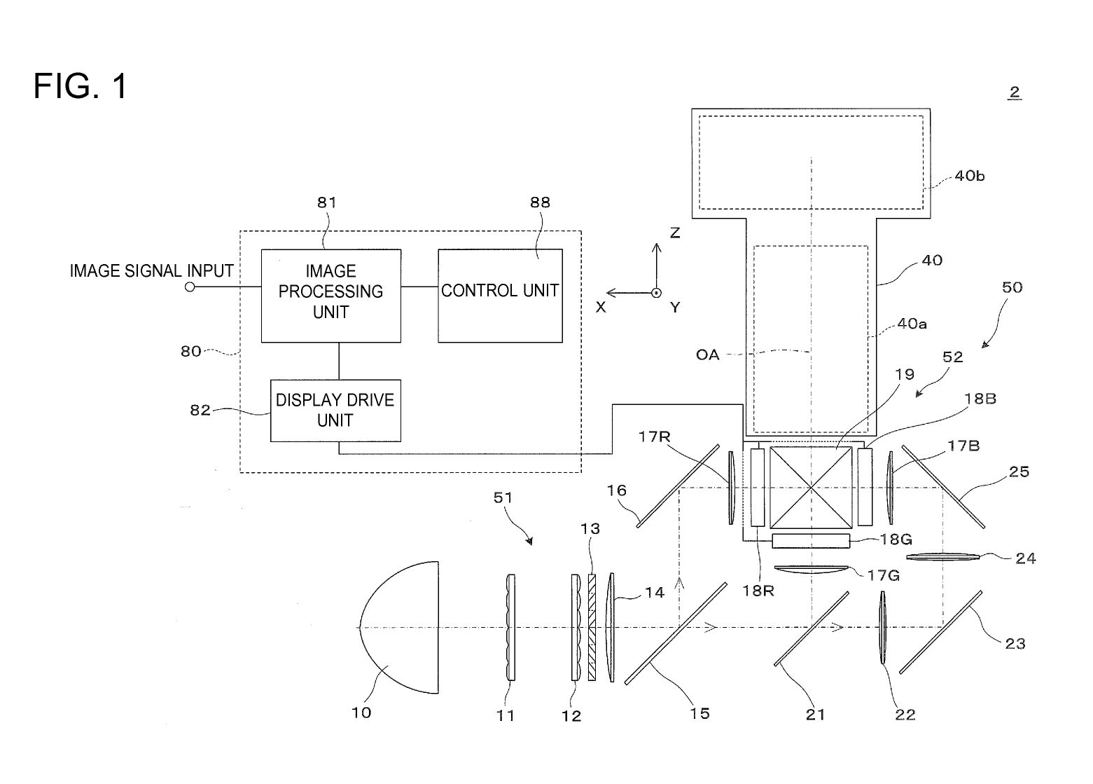

As shown in FIG. 1, the projector 2 incorporating the projection lens of the first embodiment includes an optical system portion 50 that projects image light and a circuit device 80 that controls the operation of the optical system portion 50.

In the optical system portion 50, a light source 10 is configured to include, for example, an extra-high-pressure mercury lamp, a solid-state light source, or the like. A first integrator lens 11 and a second integrator lens 12 each include a plurality of lens elements arranged in an array. The first integrator lens 11 divides luminous flux from the light source 10 into a plurality of portions. The lens elements of the first integrator lens 11 converge the luminous flux from the light source 10 to the vicinity of the lens elements of the second integrator lens 12. The lens elements of the second integrator lens 12 cooperate with a superimposing lens 14 to form images of the lens elements of the first integrator lens 11 on a liquid crystal panel 18R, a liquid crystal panel 18G, and a liquid crystal panel 18B described later.

A polarization conversion element 13 converts light from the second integrator lens 12 into predetermined linearly polarized light. The superimposing lens 14 cooperates with the second integrator lens 12 to superimpose images of the lens elements of the first integrator lens 11 on display areas of the liquid crystal panel 18R, the liquid crystal panel 18G, and the liquid crystal panel 18B.

A first dichroic mirror 15 reflects R light incident from the superimposing lens 14 while allowing G light and B light to pass therethrough. The R light reflected by the first dichroic mirror 15 is incident through a reflection mirror 16 and a field lens 17R on the liquid crystal panel 18R as a light modulation element or a display element. The liquid crystal panel 18R modulates the R light in response to an image signal to thereby form an R colored image.

A second dichroic mirror 21 reflects the G light from the first dichroic mirror 15 while allowing the B light to pass therethrough. The G light reflected by the second dichroic mirror 21 is incident through a field lens 17G on the liquid crystal panel 18G as a display element. The liquid crystal panel 18G modulates the G light in response to an image signal to thereby form a G colored image. The B light passed through the second dichroic mirror 21 is incident on the liquid crystal panel 18B as a display element through a relay lens 22, a relay lens 24, a reflection mirror 23, a reflection mirror 25, and a field lens 17B. The liquid crystal panel 18B modulates the B light in response to an image signal to thereby form a B colored image.

A cross dichroic prism 19 is a light combining prism, which combines the lights modulated by the liquid crystal panels 18R, 18G, and 18B to form image light and emits the image light to the projection lens 40.

The projection lens 40 enlarges and projects the image light modulated by the liquid crystal panels 18G, 18R, and 18B and then combined by the cross dichroic prism 19 onto a screen (not shown). The projection lens 40 includes a refracting system 40a and a reflecting system 40b, forms an intermediate image with the refracting system 40a, and enlarges and projects the intermediate image with the reflecting system 40b onto the screen (not shown).

In the optical system portion 50 described above, the cross dichroic prism 19 and the projection lens 40 constitute a projection optical system 52 for enlarging and projecting the image formed by the liquid crystal panels 18R, 18G, and 18B onto the screen. Since even the projection lens 40 alone can function as the projection optical system 52, the projection lens 40 alone may be called the projection optical system 52. The liquid crystal panels 18G, 18R, and 18B, the dichroic mirrors 15 and 21, the polarization conversion element 13, the integrator lenses 11 and 12, the light source 10, and the like, which are provided at the front stage of an optical path of the projection optical system 52 described above, function as an image forming optical unit 51.

The circuit device 80 includes an image processing unit 81 to which an external image signal such as a video signal is input, a display drive unit 82 that drives, based on output of the image processing unit 81, the liquid crystal panels 18G, 18R, and 18B provided in the optical system portion 50, and a main control unit 88 that collectively controls the operations of the image processing unit 81 and the display drive unit 82.

The image processing unit 81 converts the input external image signal into an image signal including the gray scales or the like of respective colors. The image processing unit 81 can also perform various kinds of image processing such as distortion correction or color correction on the external image signal.

The display drive unit 82 can cause the liquid crystal panels 18G, 18R, and 18B to operate based on the image signal output from the image processing unit 81 to form an image corresponding to the image signal on the liquid crystal panels 18G, 18R, and 18B.

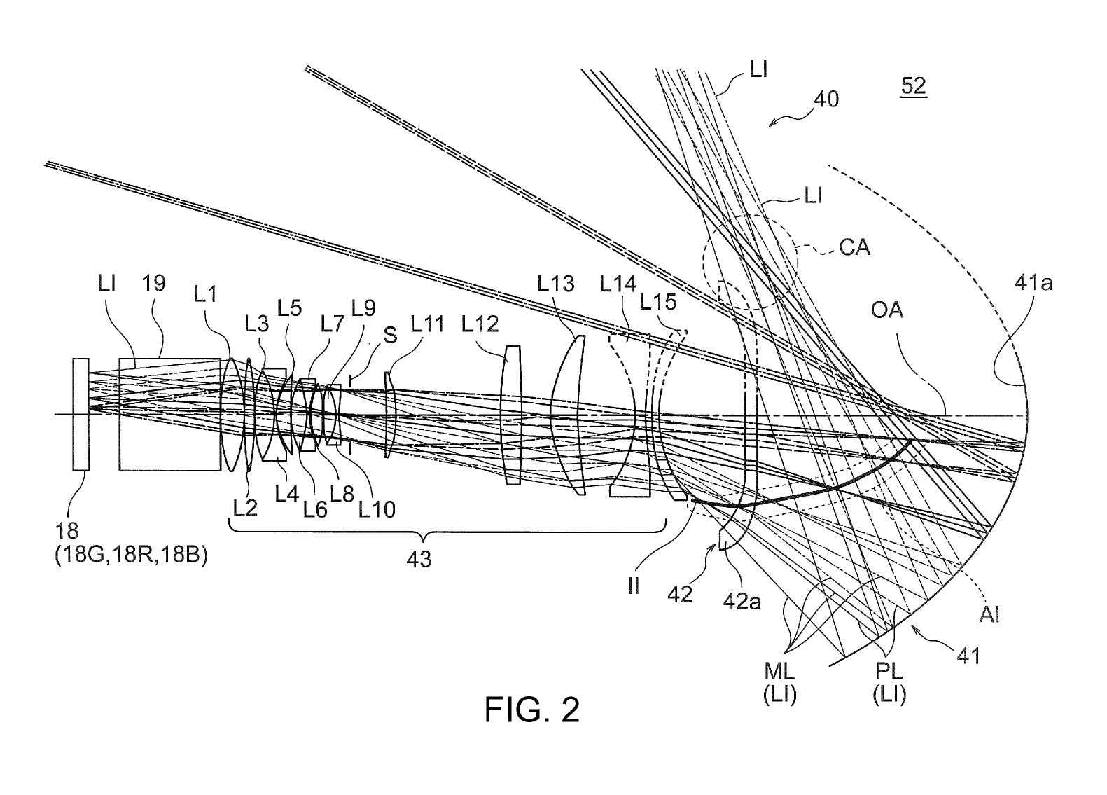

Hereinafter, the projection lens 40 according to the first embodiment and the projection optical system 52 will be specifically described with reference to FIG. 2.

The projection lens 40 of the first embodiment includes a first optical system 41, a second optical system 42, and a third optical system 43 in order from the enlargement side, that is, in order from the side opposite to the traveling direction of light. The first optical system 41 is formed of one concave mirror 41a having positive power. The second optical system 42 is formed of a single lens 42a. The third optical system 43 is configured to include a plurality of lenses L1 to L15. A diaphragm S is provided between the lens L10 and the lens L11. The third optical system 43 and the second optical system 42 in combination have positive power (refractive power). With this configuration, an intermediate image II is formed between the third optical system 43 and the first optical system 41. The intermediate image II intersects the second optical system 42. That is, a portion of the intermediate image II is formed so as to overlap the second optical system 42, that is, the single lens 42a.

In the above, the first optical system 41 corresponds to the reflecting system 40b in FIG. 1, while the second optical system 42 and the third optical system 43 correspond to the refracting system 40a in FIG. 1.

Moreover, the concave mirror 41a of the first optical system 41 is an aspheric mirror, and the single lens 42a of the second optical system 42 is a lens whose incident and exiting surfaces are aspheric surfaces.

Light LI exited from the liquid crystal panel 18 (18G, 18R, 18B) passes through the cross dichroic prism 19 and then enters the third optical system 43. The light LI exited from the third optical system 43 passes through the second optical system 42. As shown by the thick line in FIG. 2, the intermediate image II is generated at a position conjugate to the liquid crystal panel 18 and the screen (not shown), and a portion of the intermediate image II is formed in the single lens 42a of the second optical system 42. Further, the light LI passed through the second optical system 42 enters the concave mirror 41a of the first optical system 41. The light LI reflected by the concave mirror 41a is once converged at an area CA close to the concave mirror 41a, and travels toward the screen (not shown) present in the upper-left direction in FIG. 2.

It is sufficient for the first optical system 41 to have positive power. The first optical system 41 is not limited to an aspheric mirror, and may be a free-form surface mirror or the like. When a free-form surface mirror is adopted, an eccentric optical system such as shifting of an optical axis can be adopted, and thus a further downsizing can be realized.

The single lens 42a of the second optical system 42 is an aspheric lens. From the nature of the aspheric type, the optical performance or characteristics of a high image height portion (peripheral portion) can be improved by controlling high-order aspheric coefficients. Furthermore, the intermediate image II intersects the single lens 42a. That is, a portion of the intermediate image II is formed in the single lens 42a. Especially, the portion of the intermediate image II intersecting the single lens 42a is a peripheral portion that is relatively away from an optical axis OA. With this configuration, since the light LI at the high image height portion forms an image on the single lens 42a or in the vicinity thereof, peripheral rays ML of the light LI at the high image height portion are easily controlled. Here, the peripheral ray ML is a ray at the peripheral portion, which travels away from principal rays PL, among divergent lights emitted from one point of the liquid crystal panel 18.

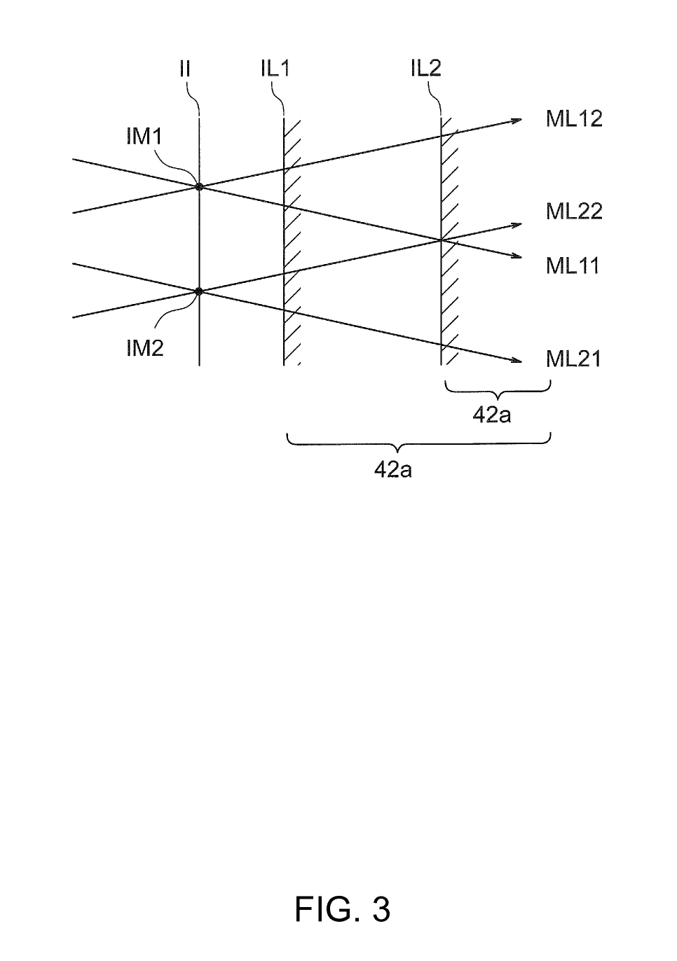

An advantageous effect of the configuration described above will be described with reference to FIG. 3. In FIG. 3, a ray ML11 and a ray ML12 are peripheral rays passed through a point IM1 of the intermediate image II, and a ray ML21 and a ray ML22 are peripheral rays passed through a point IM2 of the intermediate image II. Moreover, IL1 indicates the position of the light incident surface of the single lens 42a when a distance between the intermediate image II and the single lens 42a is relatively short, while IL2 indicates the position of the light incident surface of the single lens 42a when the distance between the intermediate image II and the single lens 42a is relatively long. When the light incident surface of the single lens 42a is disposed at the position IL2, the ray ML11 and the ray ML22 are incident on the single lens 42a in a state where the rays overlap each other. Therefore, it is difficult to design the single lens 42a so as to be able to favorably control both the ray ML11 and the ray ML22. On the other hand, when the light incident surface of the single lens 42a is disposed at the position IL1, the ray ML11 and the ray ML22 are incident on the single lens 42a in a state where the rays do not overlap each other. Therefore, it is easy to design the single lens 42a so as to be able to favorably control both the ray ML11 and the ray ML22. In FIG. 3, the advantageous effect has been described with an example in which the intermediate image II is formed on the light incident side of the single lens 42a. However, even when the intermediate image II is formed on the light exiting side of the single lens 42a, a similar advantageous effect is obtained. According to the invention as described above, since the intermediate image II is formed in the vicinity of the single lens 42a at the high image height portion, the optical path of the peripheral ray ML can be controlled for each of image heights. With this configuration, the imaging performance of the projection lens 40 can be greatly improved. That is, even when a ray that passes through a peripheral portion, which corresponds to the light LI at the high image height portion of the intermediate image II, is enlarged and projected by the concave mirror 41a of relatively small size, relatively favorable image quality can be provided.

The single lens 42a of the second optical system 42 is not limited to an aspheric lens, and may be a free-form surface lens. In this case, aberration is easily reduced with respect to the light LI at the high image height portion, so that an imaging state on the screen can be controlled more finely. Moreover, the single lens 42a may be made of glass, but can be made of plastic. When glass is adopted, even a complicated aspheric surface shape is less subjected to deformation due to temperature or external force, and thus stable projection performance can be realized. Moreover, when plastic is adopted, a complicated surface shape such as one having an inflection point can be realized, and thus rays can be finely controlled.

There are no particular limitations on the lens constituting the third optical system 43. The lens can be a combination of a spherical lens, an aspheric lens, and the like, and glass, plastic, or the like can be used for the material of the lens. It is also possible to incorporate a hybrid lens. Into the third optical system 43, a focus function can be incorporated, and a zoom function may be incorporated.

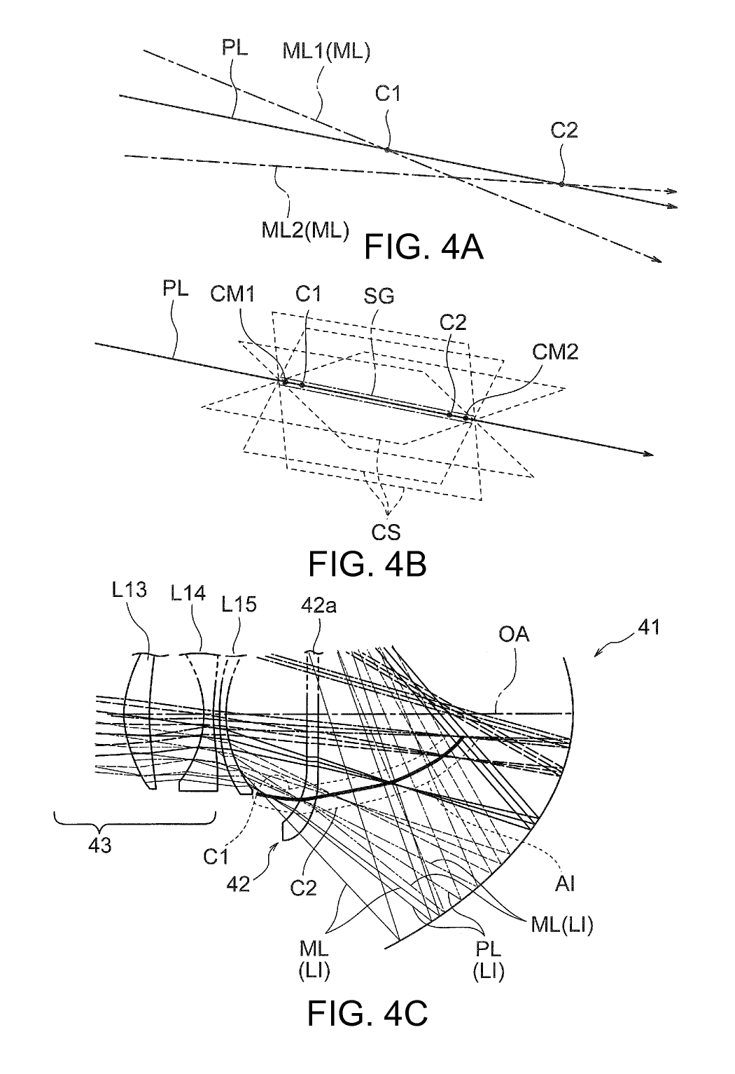

FIGS. 4A and 4B are conceptual views for explaining an imaging position of the intermediate image II in FIG. 2. Rays exited from one point of an object surface are not converged at one point due to coma aberration. Therefore, in a cross-section including the principal ray PL of the rays exited from the one point of the object surface, when an intersection point of the principal ray PL and a first outermost peripheral ray ML1 of the rays exited from the one point of the object surface is an intersection point C1, and an intersection point of the principal ray PL and a second outermost peripheral ray ML2 is an intersection point C2, a line segment connecting the intersection point C1 with the intersection point C2 is defined as an imaging point or imaging section. However, in a proximity projection-type lens like the projection lens 40 of the first embodiment, astigmatism generally occurs, and imaging characteristics around the principal ray PL are not always uniform. Therefore, a plurality of cross-sections CS are set at proper angular intervals around the principal ray PL, and the intersection point C1 and the intersection point C2 in each of the cross-sections CS are determined. Then, a segment including all of the imaging sections in the cross-sections is defined as an imaging point or imaging section SG of the rays exited from the one point of the object surface. That is, the intermediate image II shown in FIG. 2 is, to be exact, a layer-like area (area AI indicated by the dotted line in FIGS. 2 and 4C) having a thickness corresponding to the imaging section SG shown in FIG. 4B.

### Example 1

Hereinafter, Example 1, which is a specific example of the projection lens 40 of the first embodiment, will be described. A projection lens of Example 1 has the same configuration as that of the projection lens 40 shown in FIG. 2 as the first embodiment.

Table 1 shows data of lens surfaces constituting the projection lens of Example 1. In the column of “Surface Number” in Table 1 and the like, “OBJ” means an object surface, that is, the image forming surface of the liquid crystal panel 18 (18G, 18R, 18B), and “IMG” means a screen surface. “A1” to “A5” mean an aspheric surface, and “R” means a reflective surface. Further, in the column of “Material”, “BSC7_HOYA” represents the name of material, and the numerical values represent refractive indices. In the following tables including Table 1, the exponent of the power of 10 (for example, 5.26×10⁻⁰⁶) is represented using E (for example, 5.26E-06).

TABLE 1

| Surface | Radius of | Surface | |
|---|---|---|---|
| Number | Curvature | Interval | Material |
| OBJ | ∞ | 8.61 | |
| 1 | ∞ | 28 | BSC7_HOYA |
| 2 | ∞ | 0 | |
| 3 | 44.9251387 | 6.897839265 | 510675.7422 |
| 4 | −40.83785115 | 0.1 | |
| 5 | 205.1776916 | 2.753965095 | 841341.2394 |
| 6 | −80.2887044 | 0.1 | |
| 7 | 39.73653581 | 5.410892773 | 498629.8007 |
| 8 | −28.80349717 | 0.95 | 903658.3132 |
| 9 | 21.6086473 | 0.1 | |
| 10 | 18.2665586 | 3.634495115 | 499009.811 |
| 11 | 101.510395 | 0.1 | |
| 12 | 24.14316058 | 4.251114935 | 516719.7706 |
| 13 | −35.14178797 | 0.95 | 903658.3132 |
| 14 | 21.44831415 | 0.634029708 | |
| 15 | 25.47484704 | 3.279635252 | 521482.6394 |
| 16 | −45.16342785 | 0.1 | |
| 17 | 42.41693436 | 3.449810278 | 846663.2378 |
| 18 | −19.00035397 | 0.95 | 770581.4527 |
| 19 | 35.08857597 | 0.706759391 | |
| 20 | ∞ | 12.5 | |
| 21 | −132.3304113 | 2.619715974 | 641330.6053 |
| 22 | −36.94907212 | 29.45805351 | |
| 23 | 112.8294494 | 6 | 535413.6264 |
| 24 | −278.9969506 | 8.229649576 | |
| 25 | 37.26421737 | 7.5622595 | 503442.8002 |
| 26 | 148.2760882 | 15.97475348 | |
| 27(A1) | −27.31869925 | 3 | 530000.558 |
| 28(A2) | 48.73381972 | 1.793386933 | |
| 29 | 51.81426746 | 1.8 | 825739.2558 |
| 30 | 36.23859035 | 24.00123751 | |
| 31(A3) | −443.087773 | 3.5 | 530000.5583 |
| 32(A4) | −2713.091897 | 76 | |
| 33(A5)R | −51.02384029 | −700 | |
| IMG | ∞ | 0 | |

Table 2 shows data of five aspheric surfaces (A1 to A5) included in the projection lens of Example 1.

TABLE 2

| | Aspheric | Aspheric | Aspheric |
|---|---|---|---|
| | Surface 1 (A1) | Surface 2 (A2) | Surface 3 (A3) |
| Radius of | −27.31869925 | 48.73381972 | −443.087773 |
| Curvature | | | |
| Conic Constant | 0.007126797 | −9.738831238 | −47.525705 |
| (K) | | | |
| 4th-order | −5.26E−06 | −2.24E−05 | −1.49E−07 |
| coefficient (A) | | | |
| 6th-order | 6.12E−08 | 4.54E−08 | −2.66E−09 |
| coefficient (B) | | | |
| 8th-order | −3.45E−11 | −4.80E−11 | 2.46E−12 |
| coefficient (C) | | | |
| 10th-order | −2.69E−13 | −5.89E−14 | −2.66E−15 |
| coefficient (D) | | | |
| 12th-order | 7.12E−16 | 1.93E−16 | −6.68E−19 |
| coefficient (E) | | | |
| 14th-order | −5.10E−19 | −1.25E−19 | −5.52E−22 |
| coefficient (F) | | | |
| 16th-order | 0 | 0 | 0 |
| coefficient (G) | | | |
| 18th-order | 0 | 0 | 0 |
| coefficient (H) | | | |
| 20th-order | 0 | 0 | 0 |
| coefficient (J) | | | |

| | Aspheric | Aspheric |
|---|---|---|
| | Surface 4 (A4) | Surface 5 (A5) |
| Radius of | −2713.091897 | −51.02384029 |
| Curvature | | |
| Conic Constant | 4438.48311 | −3.27911843 |
| (K) | | |
| 4th-order | −1.13E−06 | −1.80E−06 |
| coefficient (A) | | |
| 6th-order | −6.60E−10 | 5.57E−10 |
| coefficient (B) | | |
| 8th-order | 1.35E−12 | −1.51E−13 |
| coefficient (C) | | |
| 10th-order | −1.14E−15 | 1.89E−17 |
| coefficient (D) | | |
| 12th-order | −1.35E−19 | 1.25E−21 |
| coefficient (E) | | |
| 14th-order | −8.21E−23 | −4.11E−25 |
| coefficient (F) | | |
| 16th-order | 0 | −1.22E−28 |
| coefficient (G) | | |
| 18th-order | 0 | 3.99E−32 |
| coefficient (H) | | |
| 20th-order | 0 | −2.95E−36 |
| coefficient (J) | | |

### Second Embodiment

A projection lens according to a second embodiment will be described in detail below. The projection lens of the second embodiment is obtained by modifying a portion of the projection lens of the first embodiment, and portions that are not particularly described are the same as those of the projection lens of the first embodiment. The projection lens according to the second embodiment is also incorporated into the projector 2 shown in FIG. 1.

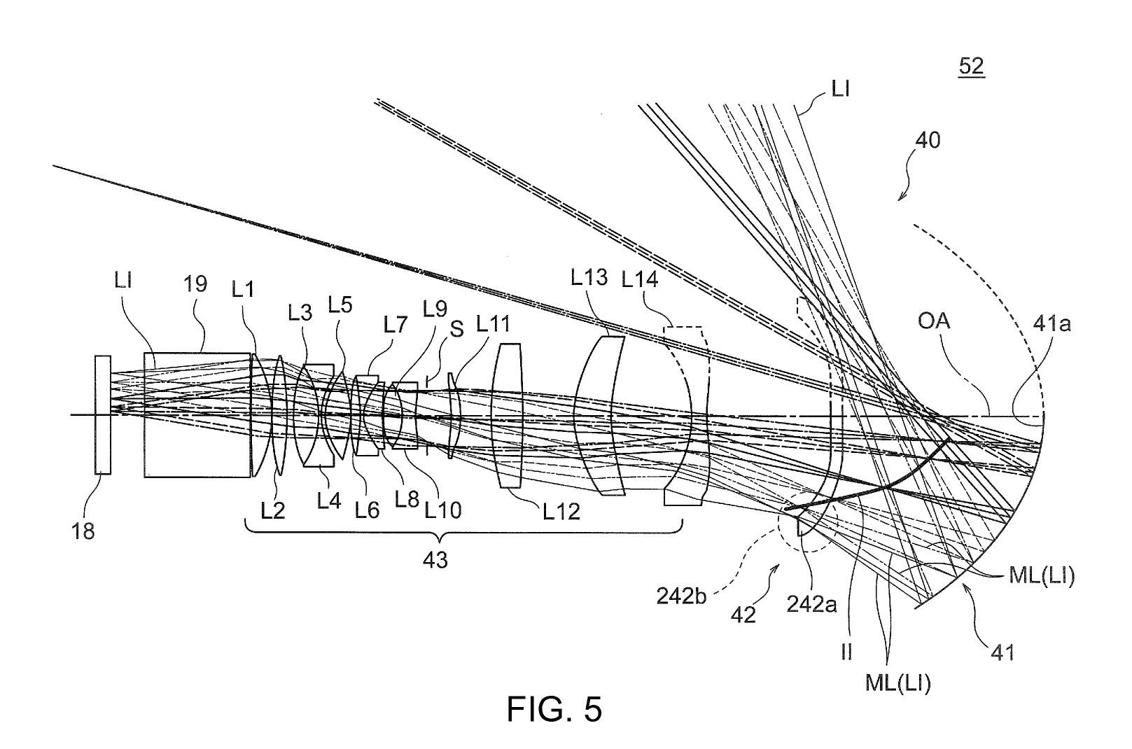

As shown in FIG. 5, the projection lens 40 of the second embodiment includes, in order from the enlargement side, the first optical system 41, the second optical system 42, and the third optical system 43. The first optical system 41 is formed of one concave mirror 41a having positive power. The second optical system 42 is formed of the single lens 42a. The third optical system 43 is configured to include a plurality of lenses L1 to L14. The diaphragm S is provided between the lens L10 and the lens L11. The third optical system 43 and the second optical system 42 in combination have positive power. With this configuration, the intermediate image II is formed between the third optical system 43 and the first optical system 41. The intermediate image II intersects the second optical system 42. That is, a portion of the intermediate image II is formed so as to overlap the second optical system 42, that is, the single lens 42a.

In the case of the embodiment, a correction function of the single lens 42a of the second optical system 42 with respect to a ray that passes through a peripheral portion, which corresponds to the light LI at a high image height portion, is enhanced. That is, if optimization is carried out so as to provide a peripheral portion 242b corresponding to the high image height portion with great refractive power in order to control higher-order terms of the aspheric surface of the single lens 42a, the light LI at the high image height portion can be selectively inclined toward the optical axis OA side. With this configuration, the first optical system 41 can be made small. Compared to the first embodiment in FIG. 2, it is understood that, in the second embodiment in FIG. 5, the light LI at the high image height portion, which passed through the single lens 42a, forms a small angle with respect to the optical axis OA, and that a position at which the light LI at the high image height portion is incident on the concave mirror 41a of the first optical system 41 is moved to the upper side (the optical axis OA side).

### Example 2

Hereinafter, Example 2, which is a specific example of the projection lens 40 of the second embodiment, will be described. A projection lens of Example 2 has the same configuration as that of the projection lens 40 shown in FIG. 5 as the second embodiment.

Table 3 shows data of lens surfaces constituting the projection lens of Example 2.

TABLE 3

| Surface | Radius of | Surface | |
|---|---|---|---|
| Number | Curvature | Interval | Material |
| OBJ | ∞ | 8.61000061 | |
| 1 | ∞ | 28 | BSC7_HOYA |
| 2 | ∞ | 0 | |
| 3 | 170.21750 | 5.585263399 | 532252.5872 |
| 4 | −36.82843 | 0.1 | |
| 5 | 76.45250 | 4.17832378 | 841033.2395 |
| 6 | −77.07972 | 1.265128234 | |
| 7 | 45.54452 | 7.514762513 | 496997.8161 |
| 8 | −24.82226 | 0.8 | 903658.3132 |
| 9 | 26.88543 | 0.100000489 | |
| 10 | 18.12040 | 6.934542005 | 496997.8161 |
| 11 | −38.53388 | 0.100001124 | |
| 12 | 74.94208 | 2.467373508 | 503423.7591 |
| 13 | −51.84830 | 0.800002432 | 903658.3132 |
| 14 | 12.74071 | 0.09999561 | |
| 15 | 13.00893 | 4.503237211 | 526837.7426 |
| 16 | 49.79540 | 0.100000157 | |
| 17 | 20.84594 | 5.582928463 | 840557.2396 |
| 18 | −13.23204 | 3.288956333 | 882571.2911 |
| 19 | 29.55437 | 3.242161005 | |
| 20 | ∞ | 6.248005218 | |
| 21 | −39.14650 | 2.939895522 | 689838.3725 |
| 22 | −20.30724 | 7.480724043 | |
| 23 | 74.26183 | 8.300870204 | 498204.813 |
| 24 | −146.08367 | 13.58393899 | |
| 25 | 38.13901 | 9.805111625 | 496999.8161 |
| 26 | 69.84795 | 21.57563334 | |
| 27(A1) | −28.62165 | 2.999936958 | 530000.558 |
| 28(A2) | 46.23319 | 32.95071695 | |
| 29(A3) | −481.56501 | 3.992507517 | 530000.5583 |
| 30(A4) | −551.24566 | 51.99999843 | |
| 31(A5)R | −42.39773 | −700 | |
| IMG | ∞ | 0 | |

Table 4 shows data of five aspheric surfaces (A1 to A5) included in the projection lens of Example 2.

TABLE 4

| | Aspheric | Aspheric | Aspheric |
|---|---|---|---|
| | Surface 1 (A1) | Surface 2 (A2) | Surface 3 (A3) |
| Radius of | −28.62165 | 46.23319 | −481.56501 |
| Curvature | | | |
| Conic Constant | 7.13817E−02 | −1.85154E+01 | 2.82369E+02 |
| (K) | | | |
| 4th-order | −7.84326E−06 | −2.23171E−05 | −1.46471E−05 |
| coefficient (A) | | | |
| 6th-order | 6.14670E−08 | 4.49498E−08 | −3.22740E−09 |
| coefficient (B) | | | |
| 8th-order | −3.02553E−11 | −5.19342E−11 | 1.05726E−11 |
| coefficient (C) | | | |
| 10th-order | −2.75904E−13 | −6.50785E−14 | 4.94039E−15 |
| coefficient (D) | | | |
| 12th-order | 6.53476E−16 | 1.80504E−16 | 6.67398E−19 |
| coefficient (E) | | | |
| 14th-order | −6.84011E−19 | −1.46460E−19 | −5.74448E−21 |
| coefficient (F) | | | |
| 16th-order | −4.87290E−22 | −3.18628E−23 | −7.96107E−24 |
| coefficient (G) | | | |
| 18th-order | −9.33533E−25 | 1.39105E−26 | −4.59968E−27 |
| coefficient (H) | | | |
| 20th-order | 4.64902E−27 | 1.37583E−28 | 6.09067E−30 |
| coefficient (J) | | | |

| | Aspheric | Aspheric |
|---|---|---|
| | Surface 4 (A4) | Surface 5 (A5) |
| Radius of | −551.24566 | −42.39773 |
| Curvature | | |
| Conic Constant | 2.71971E+02 | −2.51886E+00 |
| (K) | | |
| 4th-order | −1.39666E−05 | −1.92557E−06 |
| coefficient (A) | | |
| 6th-order | 2.06535E−09 | 5.40812E−10 |
| coefficient (B) | | |
| 8th-order | 3.16348E−12 | −1.52423E−13 |
| coefficient (C) | | |
| 10th-order | 1.04710E−16 | 1.88848E−17 |
| coefficient (D) | | |
| 12th-order | 1.89454E−18 | 1.07931E−21 |
| coefficient (E) | | |
| 14th-order | 2.22696E−21 | −6.44930E−25 |
| coefficient (F) | | |
| 16th-order | 9.66930E−25 | −2.98012E−28 |
| coefficient (G) | | |
| 18th-order | −8.80068E−28 | −2.85036E−32 |
| coefficient (H) | | |
| 20th-order | −3.24536E−30 | 4.04138E−35 |
| coefficient (J) | | |

### Third Embodiment

A projection lens according to a third embodiment will be described in detail below. The projection lens of the third embodiment is obtained by modifying a portion of the projection lens of the first embodiment, and portions that are not particularly described are the same as those of the projection lens of the first embodiment. The projection lens according to the third embodiment is also incorporated into the projector 2 shown in FIG. 1.

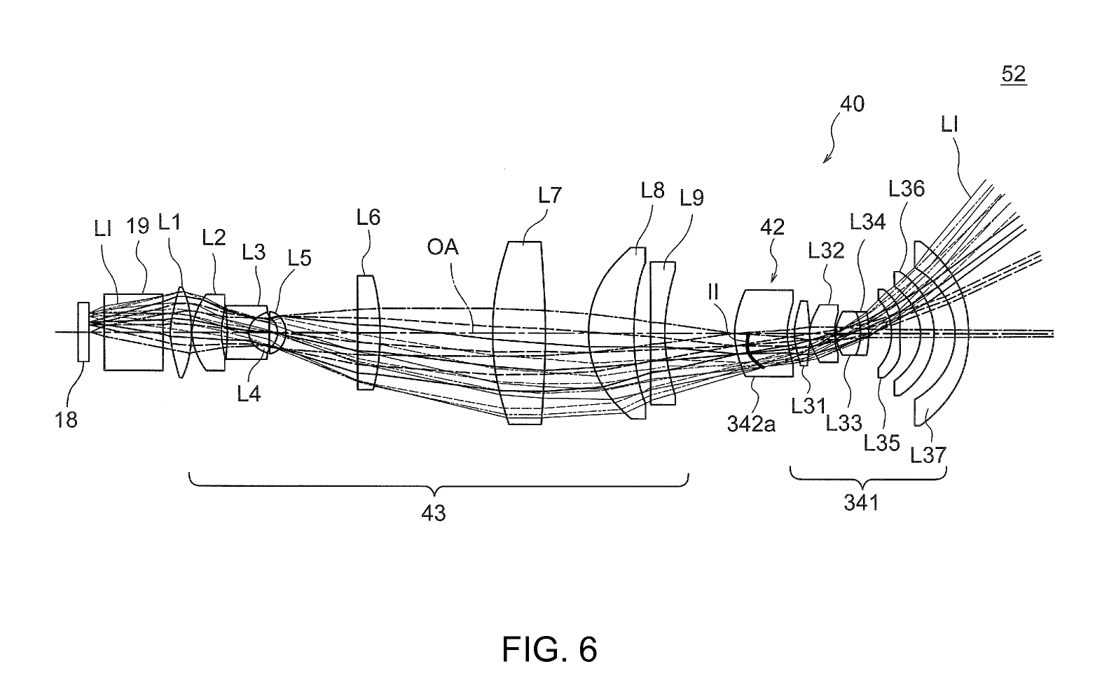

As shown in FIG. 6, the projection lens 40 of the third embodiment includes, in order from the enlargement side, a first optical system 341, the second optical system 42, and the third optical system 43. The first optical system 341 is configured to include a plurality of lenses L31 to L37, and has positive power as a whole. The second optical system 42 is formed of a single lens 342a. The third optical system 43 is configured to include a plurality of lenses L1 to L9. The third optical system 43 has positive power and forms the intermediate image II inside the single lens 342a of the second optical system 42. It can be said that the intermediate image II is formed so as to overlap the single lens 342a.

In the case of the embodiment, the first optical system 341 is a refracting system formed of the lenses L31 to L37. When the first optical system 341 is configured to include a lens system as described above, the exiting direction of the light LI can be aligned with the light exiting surface of the liquid crystal panel 18, and thus the degree of freedom of arrangement of the projection optical system is increased as a product.

### Example 3

Hereinafter, Example 3, which is a specific example of the projection lens 40 of the third embodiment, will be described. A projection lens of Example 3 has the same configuration as that of the projection lens 40 shown in FIG. 6 as the third embodiment.

Table 5 shows data of lens surfaces constituting the projection lens of Example 3.

TABLE 5

| Surface | Radius of | Surface | |
|---|---|---|---|
| Number | Curvature | Interval | Material |
| IMG | ∞ | 1.0E+13 | |
| 1 | 38.75973329 | 5 | 487490.7041 |
| 2 | 25.37400419 | 7.582113204 | |
| 3 | 25.09133148 | 4.570916838 | 487490.7041 |
| 4(A1) | 18.58142987 | 7.339716844 | |
| 5(A2) | 169.8597464 | 3.297975102 | 644662.3496 |
| 6 | 20.25285549 | 8.316833886 | |
| | 45.75188138 | 2.774096144 | 569379.5302 |
| 8 | 13.46658539 | 9.000138792 | 487490.7041 |
| 9(A3) | −13.95149435 | 0.358095771 | |
| 10(A4) | −17.27643119 | 8.864567267 | 656975.4341 |
| 11(A5) | −14.40017095 | 0.1 | |
| 12(A6) | 143.3104999 | 5.475408179 | 726262.2885 |
| 13 | −14.99336031 | 2.291627378 | |
| 14 | −31.24335638 | 19 | 568777.6304 |
| 15 | −37.94084066 | 25.27849485 | |
| 16 | −68.71394209 | 5.400854569 | 755201.2758 |
| 17 | −17607.18479 | 5.678722472 | |
| 18 | −97.94481242 | 16.28735493 | 719554.2918 |
| 19 | −38.21288975 | 15.76247393 | |
| 20 | 255.6234943 | 19 | 608009.6098 |
| 21 | −90.15833271 | 40.31689758 | |
| 22 | 79.75147216 | 7.991108312 | 679910.4464 |
| 23 | 2478.776853 | 25.9639 | |
| 24 | 7.713744407 | 3.044437352 | 513791.5751 |
| 25 | 6.412273392 | 3.111815376 | |
| 26 | 516.2923149 | 7.07266982 | 487490.7041 |
| 27 | −6.805850903 | 7.87270055 | 704892.4115 |
| 28(A7) | 85.19163614 | 2 | |
| 29(A8) | −22.25480115 | 10.812905 | 755201.2758 |
| 30(A9) | −17.13920579 | 0.249698268 | |
| 31(A10) | 39.36171896 | 7.031956168 | 755201.2758 |
| 32 | −34.76790849 | 3.059604453 | |
| 33 | ∞ | 21 | BSC7_HOYA |
| 34 | ∞ | 5.5046 | |
| OBJ | ∞ | 0 | |

Table 6 shows data of 10 aspheric surfaces (A1 to A10) included in the projection lens of Example 3.

TABLE 6

| | Aspheric | Aspheric | Aspheric |
|---|---|---|---|
| | Surface 1(A1) | Surface 2(A2) | Surface 3(A3) |
| Radius of | 169.85975 | 20.25286 | −17.27643 |
| Curvature | | | |
| Conic Constant | 0 | 0 | 0 |
| (K) | | | |
| 4th-order | 1.43227E−04 | 3.79579E−05 | 3.10012E−04 |
| coefficient (A) | | | |
| 6th-order | −4.97123E−07 | 2.64971E−09 | −2.13195E−06 |
| coefficient (B) | | | |
| 8th-order | 1.69863E−09 | 7.60452E−10 | 6.35894E−09 |
| coefficient (C) | | | |
| 10th-order | −1.02117E−12 | −7.36060E−12 | 5.76148E−11 |
| coefficient (D) | | | |

| | Aspheric | Aspheric | Aspheric |
|---|---|---|---|
| | Surface 4(A4) | Surface 5(A5) | Surface 6(A6) |
| Radius of | −14.40017 | 143.31050 | 143.31050 |
| Curvature | | | |
| Conic Constant | 0 | 0 | 0 |
| (K) | | | |
| 4th-order | −5.16299E−05 | 8.16559E−05 | 8.16559E−05 |
| coefficient (A) | | | |
| 6th-order | 2.45010E−06 | −6.98385E−07 | −6.98385E−07 |
| coefficient (B) | | | |
| 8th-order | −1.40788E−08 | 2.56384E−09 | 2.56384E−09 |
| coefficient (C) | | | |
| 10th-order | 3.27447E−11 | −8.16718E−12 | −8.16718E−12 |
| coefficient (D) | | | |

| | Aspheric | Aspheric | Aspheric |
|---|---|---|---|
| | Surface 7(A7) | Surface 8(A8) | Surface 9(A9) |
| Radius of | −22.25480 | −17.13921 | 39.36172 |
| Curvature | | | |
| Conic Constant | 0 | 0 | 0 |
| (K) | | | |
| 4th-order | 3.52817E−05 | 3.08930E−05 | 1.64128E−06 |
| coefficient (A) | | | |
| 6th-order | 5.99905E−07 | 1.72176E−08 | 2.05939E−08 |
| coefficient (B) | | | |
| 8th-order | −5.07093E−09 | 3.07558E−10 | −7.21022E−11 |
| coefficient (C) | | | |
| 10th-order | 6.41582E−12 | −2.95802E−12 | 2.23387E−13 |
| coefficient (D) | | | |

| | Aspheric |
|---|---|
| | Surface 10(A10) |
| Radius of | 39.36172 |
| Curvature | |
| Conic Constant | 0 |
| (K) | |
| 4th-order | 1.64128E−06 |
| coefficient (A) | |
| 6th-order | 2.05939E−08 |
| coefficient (B) | |
| 8th-order | −7.21022E−11 |
| coefficient (C) | |
| 10th-order | 2.23387E−13 |
| coefficient (D) | |

The invention is not limited to the embodiments or examples described above. The invention can be implemented in various forms within the scope not departing from the gist thereof.

For example, the second optical system 42 can be configured to include a plurality of lenses, or a reflection mirror can be used instead of the single lens 42a or the like of the second optical system 42.

Moreover, an object to be enlarged and projected by the projection lens 40 is not limited to the image formed by the liquid crystal panel, and may be an image formed by a light modulation element such as a digital micromirror device.

The entire disclosure of Japanese Patent Application No. 2014-098373, filed on May 12, 2014 is expressly incorporated by reference herein.

What is claimed is:

1. A projection lens comprising:
in order from an enlargement side, a first optical system;
a second optical system; and
a third optical system, wherein
at least a portion of an intermediate image is formed so as to overlap the second optical system.

2. The projection lens according to claim 1, wherein
the second optical system includes at least one lens, and
at least the portion of the intermediate image is formed so as to overlap the lens.

3. The projection lens according to claim 2, wherein
the lens provided in the second optical system is an aspheric lens.

4. The projection lens according to claim 1, wherein
the first optical system includes a concave mirror, and
the third optical system is formed of at least one lens.

5. The projection lens according to claim 2, wherein
the first optical system is formed of one concave mirror having positive power,
the second optical system is formed of a single lens, and
the third optical system is configured to include a plurality of lenses.

6. The projection lens according to claim 1, wherein
the second optical system and the third optical system in combination have positive power.

7. A projector comprising:
the projection lens according to claim 1; and
an image forming optical unit provided at a front stage of an optical path of the projection lens.

8. A projector comprising:
the projection lens according to claim 2; and
an image forming optical unit provided at a front stage of an optical path of the projection lens.

9. A projector comprising:
the projection lens according to claim 3; and
an image forming optical unit provided at a front stage of an optical path of the projection lens.

10. A projector comprising:
the projection lens according to claim 4; and
an image forming optical unit provided at a front stage of an optical path of the projection lens.

11. A projector comprising:
the projection lens according to claim 5; and
an image forming optical unit provided at a front stage of an optical path of the projection lens.

12. A projector comprising:
the projection lens according to claim 6; and
an image forming optical unit provided at a front stage of an optical path of the projection lens.
